(19) United States
(12) Patent Application Publication
(10) Pub. No.: US 2017/0135786 A1
(43) Pub. Date: May 18, 2017

(54) Endodontic Instrument With Narrow Radial Lands

(71) Applicant: Andris Jaunberzins, Brookfield, WI (US)

(72) Inventor: Andris Jaunberzins, Brookfield, WI (US)

(21) Appl. No.: 15/421,525

(22) Filed: Feb. 1, 2017

Related U.S. Application Data
(63) Continuation-in-part of application No. 13/945,696, filed on Jul. 18, 2013.

(51) Int. Cl. A61C 5/42

(52) U.S. Cl. CPC A61C 5/42; A61C 2201/007

(57) ABSTRACT

An endodontic file includes a uniform tapered working length made of shape memory material with at least two helical shaped flutes and narrow spiraled lands in between, having a width no greater than 0.075 mm as measured in a plane perpendicular the central axis of rotation of instrument. The land width is preferably constant along the working length but may vary provided the width of the lands in a waist portion of the file are no greater than those above or below the waist portion. The instrument resists mid-root transportation and exhibits superior fatigue performance and cutting efficiency compared to prior art instruments.

### CROSS REFERENCE TO CO-PENDING APPLICATIONS

This application is a continuation-in-part of, and claims priority to, U.S. patent application Ser. 13/945,696 filed Jul. 18, 2013.

### BACKGROUND OF THE INVENTION

Field of the Invention.

This invention relates generally to the field of dentistry and more particularly to endodontic files or reamers used in the cleaning of material present in the root canal of human teeth and for enlarging and shaping the root canal so that it is prepared for receiving filling material.

Description of the Related Art.

Instruments that enable an endodontist to clear and clean the root canal of a tooth are well-known in the art. Because of the geometry of a root canal, these instruments—typically referred to as endodontic files—experience significant flexing and twisting while in use, making them susceptible to breakage. Because of the breakage problem and the danger that it poses to a patient, nickel-titanium alloy (NiTi or Nitinol™) generally is viewed as a better material for use in manufacturing these instruments than is stainless steel. Relative to stainless steel, NiTi is able to withstand a far greater amount of twisting or bending without experiencing permanent deformation or breaking.

The design challenge is multi-dimensional: to provide a NiTi instrument that is flexible, resists torsional breakage and cyclic fatigue, cuts efficiently, and does not transport the root canal during cutting. Unfortunately, these design objectives run counter to one another. Therefore, prior art instrument designs represent the various tradeoffs made among these objectives. To date, all the prior art instrument designs teach away from providing narrow radial land widths along the entire working length of a straight or uniform taper instrument.

The prior art has assumed that radial lands in the range of at least 0.004 to 0.006 inches (about 0.102 to 0.152 mm) are required to get optimum cutting and guide use when a standard K-file or reamer is employed in a curved root canal. See e.g., U.S. Pat. Nos. 4,934,934 to Arpaio, Jr. et al.; Re. 34,439 (reissue of 4,871,312) and 5,762,497 to Heath; and 5,941,760 to Heath et al. To achieve this performance, the land width selected in this range should be held constant along the working length of the instrument. However, land widths must be increased to prevent transportation of the canal path. See e.g., U.S. Pat. App. Pub. No. 2007/0026360 to Buchanan.

Where lands having a width below 0.004 inches (about 0.102 mm) are disclosed, the instrument shape is altered from a uniform or straight taper shape and the narrow lands are only located at the tip and shank portions of the instrument. For example, U.S. Pat. App. Pub. No. 2007/0026360 to Buchanan discloses a land width below that of Arpaio, Jr. and Heath, in the range of 0 to 0.004 inches, except for lands located along an under-contoured (narrower) intermediate or middle waist portion of the working length. The lands in the waist portion are relatively wide—for example, in the range of 0.004 to 0.006 inches—compared to those in the tip and shank portions. Buchanan claims that the combination of multiple contours or heights and multiple land width variations along the working length reduces taper lock, increases cutting efficiency, and minimizes or eliminates transportation. See Buchanan at para. 0030 (noting “the wider land in the mid-region of the instrument prevents or minimizes straightening of curved canals at their mid-points.”) Similar to Arpaio, Jr. and Heath, Buchanan also discloses that a wide land width prevents transportation of the root canal path but increases the likelihood of breakage due to cyclic fatigue because of reduced cutting efficiency (therefore requiring more revolutions to accomplish a certain shaping objective). On the other hand, a narrow land width reduces the likelihood of breakage because of increased cutting efficiency but increases the chances of mid-root transportation.

Buchanan also found that a straight taper instrument having narrow land widths toward the shank end of the instrument and relatively wider land widths toward the tip end increases mid-root transportation to unacceptable levels. See Buchanan at para. 0006. This transportation is most likely the result of stiffness created by the increasing land widths in the waist portion of the instrument. Additionally, as the width of the radial land increases, torque strength increases but so does drag.

Subsequent testing by the Applicant has discovered that a straight taper instrument having narrow land widths in the shank and tip portions but wider lands in the waist portion does lead to stiffness, which is evidenced by stress concentrations in the waist portion as the instrument traverses a curved portion of a root canal. The Applicant also has conducted experimentation with instruments having a wider waist portion relative to the shank and tip end portions and narrow lands along the length of the instrument. These instruments also experienced unacceptable mid-root transportation. The Applicant then decided to manufacture a straight taper K-file having narrow radial lands along its entire length. Unexpectedly and surprisingly, the instrument exhibited no mid-root transportation in addition to superior cutting performance and resistance to cyclic fatigue. Preferred embodiments of this file are disclosed herein.

### SUMMARY OF THE INVENTION

An improved endodontic file made according to this invention eliminates mid-root transportation but not at the expense of flexibility, cyclic fatigue, and cutting performance. The file has a uniform tapered working length made out of shape memory material and includes spiraled right hand twist flutes with radial lands in between having a land width no greater than 0.101 mm (0.0039 inches) as measured in a plane perpendicular the central axis of rotation of the instrument.

Because the file is operated in a clockwise direction during use, the right-hand twist or orientation allows the file to transport debris toward the shank end of the file rather than compact it further into a root canal. The land width may vary along the working length provided that it does not exceed 1 or 2 degrees of arc and is preferably no greater 0.101 mm at any diameter location Dₙ along the working length, n being in a range of 1 to the total working length of the file. The taper is preferably in the range of 0.02 to 0.08 mm per mm, with the instrument size being in the range of 8 to 70. Preferably, the land width is in a range of 0.025 mm (0.001 in.) to 0.051 mm (0.002 in.) or, even more preferably, in a range of 0.025 mm to 0.034 mm (0.0013 in.), with an 0.04 to 0.06 taper and the instrument size in a range of 20 to 70.

The uniform tapered working length portion of the file—that is, the portion that includes the spiraled flutes and narrow radial lands—is made of bendable, shape memory material such as nickel titanium or its equivalent. The uniform tapered working length portion has a total length N between a shank end and a tip end of the working length, with diameters Dₙ, where n is an integer distance in a range of 1 to N in mm as measured from the tip end, N being no greater than 16 as measured in mm. A mid- or waist portion of the file is located in a range of D4 to D_{H}. The waist portion has the same uniform taper as the portion of the file below D₄ and above D_{H}.

An object of this invention is to provide an improved endodontic instrument that provides superior cutting performance and resistance to cyclic fatigue. Another object of this invention is to provide an endodontic instrument that does not transport the root canal as the instrument navigates and shapes a curved portion of the canal.

### BRIEF DESCRIPTION OF THE DRAWINGS

FIG. 1 is a view of a preferred embodiment of an endodontic file according to this invention. The file has a uniform taper, at least two helical flutes, and narrow radial lands located between the helical flutes along the entire working length of the file.

FIG. 2 is a view taken along section line 2-2 of FIG. 1 illustrating a preferred embodiment of the endodontic file. The file has four substantially straight helical flute surfaces with narrow radial lands located between each adjacent pair of flutes. The cutting edges provide a neutral rake angle (−15° or less). FIG. 3 is a view taken along section line 3-3 of FIG. 1 illustrating another preferred embodiment of the endodontic file. The file has four concave-shaped helical flutes with narrow radial lands located between each adjacent pair of flutes. The cutting edges provide a neutral rake angle.

FIG. 4 is a view taken along section line 4-4 of FIG. 1 illustrating yet another preferred embodiment of the endodontic file. The file has three substantially straight helical flute surfaces with narrow radial lands located between each adjacent pair of flutes. The cutting edges provide a neutral rake angle.

FIG. 5 is a view taken along section line 5-5 of FIG. 1 illustrating yet another preferred embodiment of the endodontic file having three concave-shaped helical flutes defined by a radius of curvature and forming narrow radial lands between each adjacent flute. The cutting edges provide a neutral rake angle.

FIG. 6 is a view taken along section line 6-6 of FIG. 1 illustrating another preferred embodiment of the endodontic file. The file has three convex-shaped helical flutes with narrow radial lands located between each adjacent pair of flutes. The cutting edges provide a neutral rake angle.

FIG. 7 is a graphical depiction of a prior art endodontic file having wide lands in the mid-portion of the working length—or alternatively narrow lands in a wider mid-portion of the working length—as the working length of the file would appear when traversing a curved root canal.

FIG. 8 is a graphical depiction of the endodontic file of FIG. 1 as its working length would appear when traversing a curved root canal.

FIG. 9 is an enlarged view of the curved and stressed mid-portion of the working length of the prior art endodontic file of FIG. 7. Because of the wide lands (or the wider waist portion) the mid-portion experiences severe and moderate stress concentrations which make it prone to cyclic fatigue and breakage.

FIG. 10 is a view an enlarged view of the mid-portion of endodontic file of FIG. 8. The narrow lands in the mid-portion eliminate the areas of stress concentration which are experienced by the wider landed or wider waist file of FIG. 9.

FIG. 11 is a view of the prior art endodontic file of FIG. 7 as it traverses a curved root canal and experiences mid-root transportation.

FIG. 12 is a view of the file of FIG. 1 as it traverses a curved root canal. The file experiences no mid-root transportation.

### DETAILED DESCRIPTION OF THE PREFERRED EMBODIMENTS

Preferred embodiments of an endodontic file made according to this invention will now be described in reference to the drawings and the following element numbering:

| | |
|---|---|
| 10 | Endodontic file |
| 11 | Flute surfaces |
| 13 | Shank or proximal end |
| 14 | Waist or mid-portion |
| 15 | Tip or distal end |
| 17 | Radial land |
| 19 | Central axis of rotation |
| 20 | Plane perpendicular to 19 |
| 21 | Handle portion |
| 23 | Depth calibration grooves |
| 24 | Working length |
| 25 | Transportation |
| 27 | Area of moderate stress concentration |
| 29 | Area of severe stress concentration |

For the purpose of this disclosure, an endodontic file is a tapered and pointed metal file with a right-hand flute orientation and cutting edges used to enlarge the root canal by clockwise rotation or filing action. Unlike pluggers, compactors, or spreaders—which are left-hand oriented, flat-ended, and designed for use in obturation techniques to compact material vertically downward within a prepared root canal and cannot be used to prepare a canal, see e.g., McSpadden (U.S. Pat. No. 4,457,710) and Heath et al. (U.S. Pat. No. 5,302,129)—an endodontic file is designed to prepare (clean, cut and shape) a root canal and extract canal material out of the canal so that a plugger, compactor, or spreader may be used.

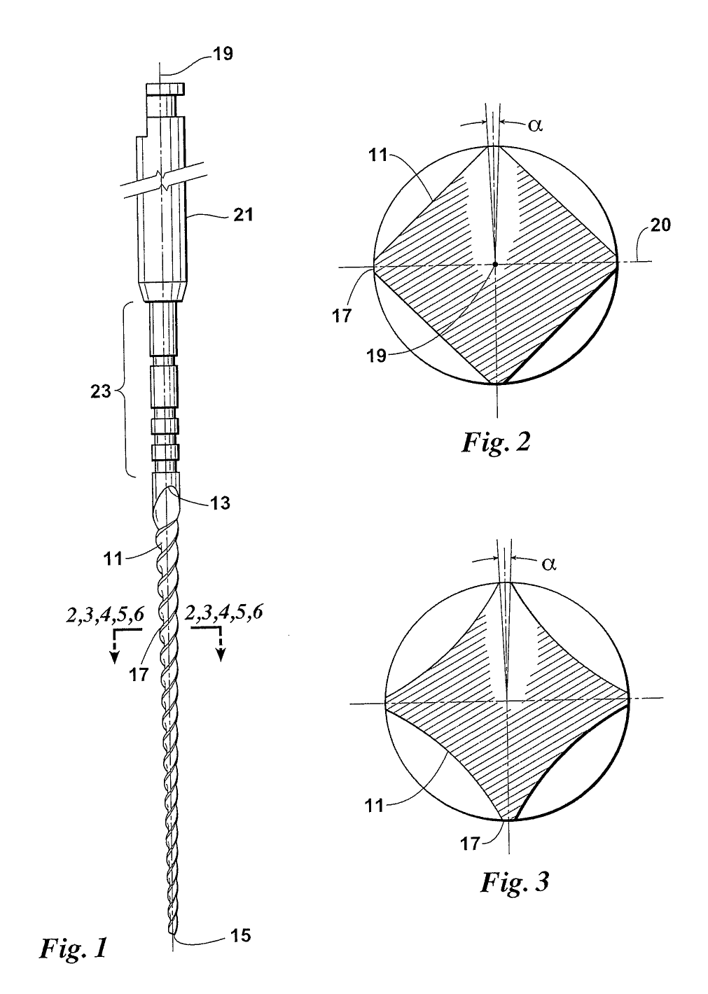

Referring first to FIG. 1, an endodontic file 10 includes two or more continuously spiraled flute surfaces 11 extending between the shank end 13 and tip end 15 of the file 10. Adjacent flute surfaces 11 form a radial land 17 that provides an edge for cutting or scraping the wall of a root canal in order to shape the canal as the file 10 is manually or mechanically manipulated about its central axis of rotation 19. Preferably, the edge has a neutral rake angle of −15° or less. Therefore, the radial lands 17 are located along the active portion or working length 24 that lies between the shank and tip ends 13, 15. Working length 24 is preferably about 16 mm to 25 mm in length and follows a predetermined straight or uniform taper so that the diameter at its tip end 15 is less than the diameter at its the shank end 13. Although not forming a part of this invention, the handle portion 21 of file 10 may be configured for manual or mechanical manipulation and includes depth calibration grooves 23.

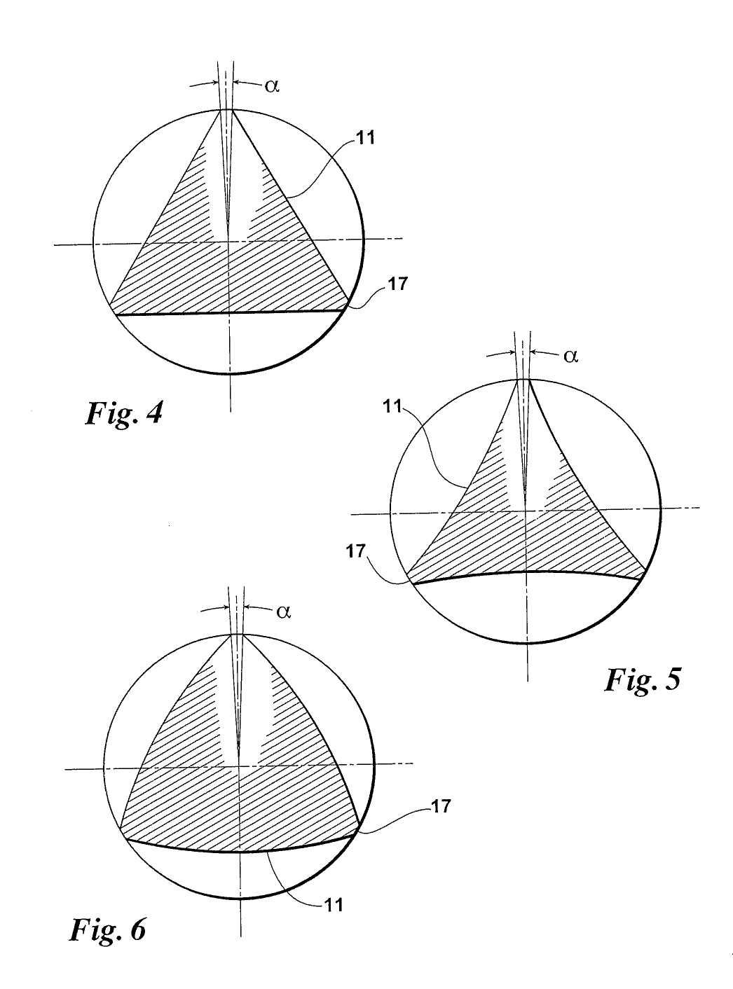

Referring now to FIGS. 2 to 6, the flute surfaces 11 may be straight, convex or concave surfaces that form radial lands 17. The cross-sectional shape of the working length 24 is preferably constant. That is to say, the desired number and shape of flute surfaces 11 do not change from one cross-section to the next along working length 24. At any diameter along the working length 24, the cross-section or core of the file 10 is greater than half the area represented by a circle drawn about the cross-section, the lands 17 lying on, and forming points of, the circle (see e.g. FIG. 2).

Central to this invention is that the radial lands 17 are narrow lands, meaning that their width as measured in a plane 20 lying perpendicular to the central axis of rotation 19 is no greater than 0.0039 inches (0.101 mm) and preferably less than 0.101 mm. In one preferred embodiment, the radial lands 17 were so narrow as to appear to form a sharp point, much less than 0.1 mm.

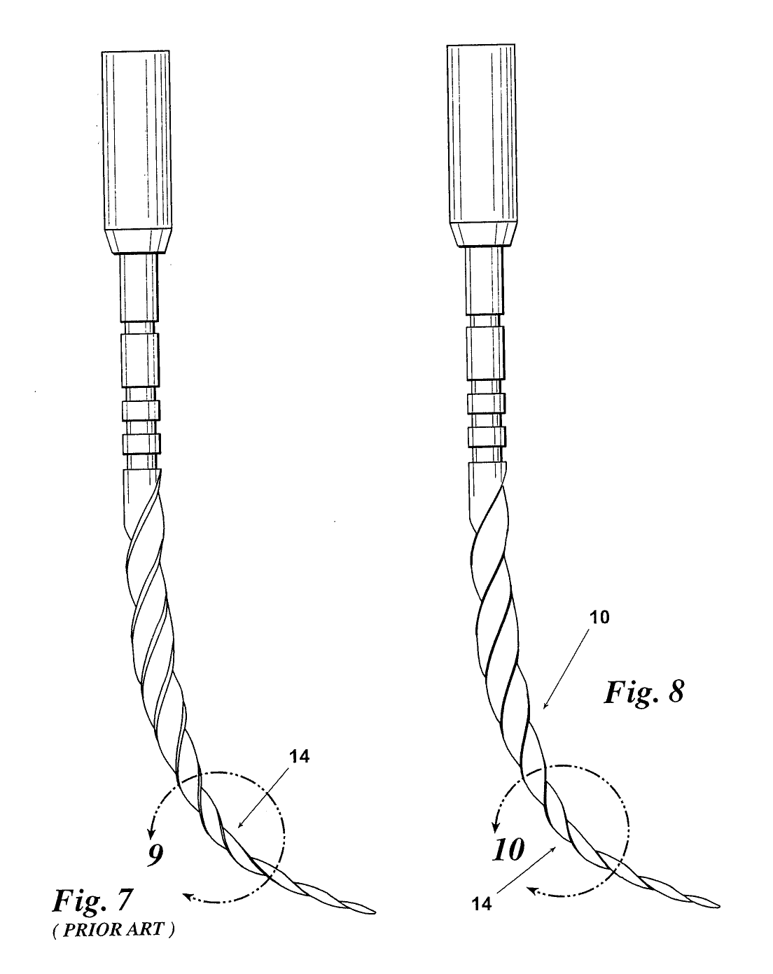

Measured in terms of degrees of arc a, the maximum degrees of arc a at each diameter Dn for various sizes of files having a 0.02 mm per mm taper does not exceed those as listed in Table 1, where n is the distance in millimeters from tip end 15. For example, a size 8 file having a 0.02 taper has a D1 diameter of 0.08 mm and a D2 of 0.10. A size 8 file having a 0.08 taper has a D1 and D2 diameter of 0.08 and 0.16 mm, respectively. To calculate the maximum degrees of arc “a” at any given cross-section “n” so as to not exceed a predetermined maximum land width “w” at that cross-section “n” for any given size file “s” and taper “t”, the following formula may be used:

$$Max {α}_{n} = \frac{360 {w}_{n}}{π [ ( n - 1 ) t + s ]}$$

where “n” is measured from the tip end of the file and “s” is the file size in hundredths (e.g., size 8 equates to an “s” of 0.08 mm). The land width, w, can be calculated using this same formula by solving for w (see Tables 2 and 3). Preferably, the land width does not exceed 1 or 2 degrees of arc, α, and a maximum width of no greater than 0.101 mm can be set along the entire working length. More preferably, the land width is in a range of 0.025 mm (0.001 in.) to 0.051 mm (0.002 in.) or 0.075 mm (0.003 in.) or, even more preferably, in a range of 0.025 mm to 0.034 mm (0.0013 in.),It has always been assumed by the designers of endodontic files that wider radial lands are needed in the waist portion 14 of the file to keep the file from transporting the root canal. The waist portion 14 generally begins about 9 to 11 mm from proximal end 13 and ends about 2½to 3 mm from the tip end 15, respectively (or about 9 to 11 mm from the distal end. However, referring now to FIGS. 7, 9 & 11, digital photography revels that a prior art endodontic file having narrower radial lands at the shank and tip portions 13, 15 and wider radial lands at the waist portion 14 still experiences unacceptable levels of mid-root transportation 25 as the file navigates about a 45° curvature of a simulated root canal R in a resin block B.

Thermal spectroscopy also reveals areas of moderate 27 and severe 29 stress concentration in the waist portion 14 as the prior art file traverses the curvature of canal R. These areas of stress concentration 27, 29 negatively affect the cyclic fatigue performance of the file. These findings are in line with those of Buchanan, as was discussed in the Background section. However, Buchanan, in keeping with conventional wisdom, tried to solve the problem by keeping the wider lands in the waist portion 14 but altering the contour of the file.

TABLE 1
Maximum degrees of arc to achieve an arc length no greater than 0.101 mm at the D₁
to D₁₆ diameters for various file sizes having a 0.02 taper.

| File | Working length diameter Dₙ | | | | | | | | | | | | | | | |
|---|---|---|---|---|---|---|---|---|---|---|---|---|---|---|---|---|
| Size | 1 | 2 | 3 | 4 | 5 | 6 | 7 | 8 | 9 | 10 | 11 | 12 | 13 | 14 | 15 | 16 |
| 8 | 145 | 116 | 96 | 83 | 72 | 64 | 58 | 53 | 48 | 45 | 41 | 39 | 36 | 34 | 32 | 30 |
| 10 | 116 | 96 | 83 | 72 | 64 | 58 | 53 | 48 | 45 | 41 | 39 | 36 | 34 | 32 | 30 | 29 |
| 15 | 77 | 68 | 61 | 55 | 50 | 46 | 43 | 40 | 37 | 35 | 33 | 31 | 30 | 28 | 27 | 26 |
| 20 | 58 | 53 | 48 | 45 | 41 | 39 | 36 | 34 | 32 | 30 | 29 | 28 | 26 | 25 | 24 | 23 |
| 25 | 46 | 43 | 40 | 37 | 35 | 33 | 31 | 30 | 28 | 27 | 26 | 25 | 24 | 23 | 22 | 21 |
| 30 | 39 | 36 | 34 | 32 | 30 | 29 | 28 | 26 | 25 | 24 | 23 | 22 | 21 | 21 | 20 | 19 |
| 35 | 33 | 31 | 30 | 28 | 27 | 26 | 25 | 24 | 23 | 22 | 21 | 20 | 20 | 19 | 18 | 18 |
| 40 | 29 | 28 | 26 | 25 | 24 | 23 | 22 | 21 | 21 | 20 | 19 | 19 | 18 | 18 | 17 | 17 |
| 45 | 26 | 25 | 24 | 23 | 22 | 21 | 20 | 20 | 19 | 18 | 18 | 17 | 17 | 16 | 16 | 15 |
| 50 | 23 | 22 | 21 | 21 | 20 | 19 | 19 | 18 | 18 | 17 | 17 | 16 | 16 | 15 | 15 | 14 |
| 55 | 21 | 20 | 20 | 19 | 18 | 18 | 17 | 17 | 16 | 16 | 15 | 15 | 15 | 14 | 14 | 14 |
| 60 | 19 | 19 | 18 | 18 | 17 | 17 | 16 | 16 | 15 | 15 | 14 | 14 | 14 | 13 | 13 | 13 |
| 70 | 17 | 16 | 16 | 15 | 15 | 14 | 14 | 14 | 13 | 13 | 13 | 13 | 12 | 12 | 12 | 12 |
| 80 | 14 | 14 | 14 | 13 | 13 | 13 | 13 | 12 | 12 | 12 | 12 | 11 | 11 | 11 | 11 | 11 |
| 90 | 13 | 13 | 12 | 12 | 12 | 12 | 11 | 11 | 11 | 11 | 11 | 10 | 10 | 10 | 10 | 10 |
| 100 | 12 | 11 | 11 | 11 | 11 | 11 | 10 | 10 | 10 | 10 | 10 | 9 | 9 | 9 | 9 | 9 |
| 110 | 11 | 10 | 10 | 10 | 10 | 10 | 9 | 9 | 9 | 9 | 9 | 9 | 9 | 9 | 8 | 8 |
| 120 | 10 | 9 | 9 | 9 | 9 | 9 | 9 | 9 | 9 | 8 | 8 | 8 | 8 | 8 | 8 | 8 |
| 130 | 9 | 9 | 9 | 9 | 8 | 8 | 8 | 8 | 8 | 8 | 8 | 8 | 8 | 7 | 7 | 7 |
| 140 | 8 | 8 | 8 | 8 | 8 | 8 | 8 | 8 | 7 | 7 | 7 | 7 | 7 | 7 | 7 | 7 |
| 150 | 8 | 8 | 8 | 7 | 7 | 7 | 7 | 7 | 7 | 7 | 7 | 7 | 7 | 7 | 7 | 6 |

TABLE 2
Land width (in ten thousandths mm) for 2 degrees of arc at D1 to D16 diameters
for various file sizes having a 0.02 taper.

| | Working length diameter Dn | | | | | | | | | | | | | | | |
|---|---|---|---|---|---|---|---|---|---|---|---|---|---|---|---|---|
| Size | 1 | 2 | 3 | 4 | 5 | 6 | 7 | 8 | 9 | 10 | 11 | 12 | 13 | 14 | 15 | 16 |
| 8 | 14 | 17 | 21 | 24 | 28 | 31 | 35 | 38 | 42 | 45 | 49 | 52 | 56 | 59 | 63 | 66 |
| 10 | 17 | 21 | 24 | 28 | 31 | 35 | 38 | 42 | 45 | 49 | 52 | 56 | 59 | 63 | 66 | 70 |
| 15 | 26 | 30 | 33 | 37 | 40 | 44 | 47 | 51 | 54 | 58 | 61 | 65 | 68 | 72 | 75 | 79 |
| 20 | 35 | 38 | 42 | 45 | 49 | 52 | 56 | 59 | 63 | 66 | 70 | 73 | 77 | 80 | 84 | 87 |
| 25 | 44 | 47 | 51 | 54 | 58 | 61 | 65 | 68 | 72 | 75 | 79 | 82 | 86 | 89 | 93 | 96 |
| 30 | 52 | 56 | 59 | 63 | 66 | 70 | 73 | 77 | 80 | 84 | 87 | 91 | 94 | 98 | 101 | 105 |
| 35 | 61 | 65 | 68 | 72 | 75 | 79 | 82 | 86 | 89 | 93 | 96 | 99 | 103 | 106 | 110 | 113 |
| 40 | 70 | 73 | 77 | 80 | 84 | 87 | 91 | 94 | 98 | 101 | 105 | 108 | 112 | 115 | 119 | 122 |
| 45 | 79 | 82 | 86 | 89 | 93 | 96 | 99 | 103 | 106 | 110 | 113 | 117 | 120 | 124 | 127 | 131 |
| 50 | 87 | 91 | 94 | 98 | 101 | 105 | 108 | 112 | 115 | 119 | 122 | 126 | 129 | 133 | 136 | 140 |
| 55 | 96 | 99 | 103 | 106 | 110 | 113 | 117 | 120 | 124 | 127 | 131 | 134 | 138 | 141 | 145 | 148 |
| 60 | 105 | 108 | 112 | 115 | 119 | 122 | 126 | 129 | 133 | 136 | 140 | 143 | 147 | 150 | 154 | 157 |
| 70 | 122 | 126 | 129 | 133 | 136 | 140 | 143 | 147 | 150 | 154 | 157 | 161 | 164 | 168 | 171 | 175 |
| 80 | 140 | 143 | 147 | 150 | 154 | 157 | 161 | 164 | 168 | 171 | 175 | 178 | 182 | 185 | 188 | 192 |
| 90 | 157 | 161 | 164 | 168 | 171 | 175 | 178 | 182 | 185 | 188 | 192 | 195 | 199 | 202 | 206 | 209 |
| 100 | 175 | 178 | 182 | 185 | 188 | 192 | 195 | 199 | 202 | 206 | 209 | 213 | 216 | 220 | 223 | 227 |
| 110 | 192 | 195 | 199 | 202 | 206 | 209 | 213 | 216 | 220 | 223 | 227 | 230 | 234 | 237 | 241 | 244 |
| 120 | 209 | 213 | 216 | 220 | 223 | 227 | 230 | 234 | 237 | 241 | 244 | 248 | 251 | 255 | 258 | 262 |
| 130 | 227 | 230 | 234 | 237 | 241 | 244 | 248 | 251 | 255 | 258 | 262 | 265 | 269 | 272 | 276 | 279 |
| 140 | 244 | 248 | 251 | 255 | 258 | 262 | 265 | 269 | 272 | 276 | 279 | 283 | 286 | 290 | 293 | 297 |
| 150 | 262 | 265 | 269 | 272 | 276 | 279 | 283 | 286 | 290 | 293 | 297 | 300 | 304 | 307 | 311 | 314 |

TABLE 3
Land width (in ten thousandths mm) for 2 degrees of arc at D1 to D16 diameters
for various file sizes having a 0.08 taper.

| | Working length diameter Dn | | | | | | | | | | | | | | | |
|---|---|---|---|---|---|---|---|---|---|---|---|---|---|---|---|---|
| Size | 1 | 2 | 3 | 4 | 5 | 6 | 7 | 8 | 9 | 10 | 11 | 12 | 13 | 14 | 15 | 16 |
| 8 | 14 | 28 | 42 | 56 | 70 | 84 | 98 | 112 | 126 | 140 | 154 | 168 | 182 | 195 | 209 | 223 |
| 10 | 17 | 31 | 45 | 59 | 73 | 87 | 101 | 115 | 129 | 143 | 157 | 171 | 185 | 199 | 213 | 227 |
| 15 | 26 | 40 | 54 | 68 | 82 | 96 | 110 | 124 | 138 | 152 | 166 | 180 | 194 | 208 | 222 | 236 |
| 20 | 35 | 49 | 63 | 77 | 91 | 105 | 119 | 133 | 147 | 161 | 175 | 188 | 202 | 216 | 230 | 244 |
| 25 | 44 | 58 | 72 | 86 | 99 | 113 | 127 | 141 | 155 | 169 | 183 | 197 | 211 | 225 | 239 | 253 |
| 30 | 52 | 66 | 80 | 94 | 108 | 122 | 136 | 150 | 164 | 178 | 192 | 206 | 220 | 234 | 248 | 262 |
| 35 | 61 | 75 | 89 | 103 | 117 | 131 | 145 | 159 | 173 | 187 | 201 | 215 | 229 | 243 | 257 | 271 |
| 40 | 70 | 84 | 98 | 112 | 126 | 140 | 154 | 168 | 182 | 195 | 209 | 223 | 237 | 251 | 265 | 279 |
| 45 | 79 | 93 | 106 | 120 | 134 | 148 | 162 | 176 | 190 | 204 | 218 | 232 | 246 | 260 | 274 | 288 |
| 50 | 87 | 101 | 115 | 129 | 143 | 157 | 171 | 185 | 199 | 213 | 227 | 241 | 255 | 269 | 283 | 297 |
| 55 | 96 | 110 | 124 | 138 | 152 | 166 | 180 | 194 | 208 | 222 | 236 | 250 | 264 | 278 | 291 | 305 |
| 60 | 105 | 119 | 133 | 147 | 161 | 175 | 188 | 202 | 216 | 230 | 244 | 258 | 272 | 286 | 300 | 314 |
| 70 | 122 | 136 | 150 | 164 | 178 | 192 | 206 | 220 | 234 | 248 | 262 | 276 | 290 | 304 | 318 | 332 |
| 80 | 140 | 154 | 168 | 182 | 195 | 209 | 223 | 237 | 251 | 265 | 279 | 293 | 307 | 321 | 335 | 349 |
| 90 | 157 | 171 | 185 | 199 | 213 | 227 | 241 | 255 | 269 | 283 | 297 | 311 | 325 | 339 | 353 | 367 |
| 100 | 175 | 188 | 202 | 216 | 230 | 244 | 258 | 272 | 286 | 300 | 314 | 328 | 342 | 356 | 370 | 384 |
| 110 | 192 | 206 | 220 | 234 | 248 | 262 | 276 | 290 | 304 | 318 | 332 | 346 | 360 | 374 | 387 | 401 |
| 120 | 209 | 223 | 237 | 251 | 265 | 279 | 293 | 307 | 321 | 335 | 349 | 363 | 377 | 391 | 405 | 419 |
| 130 | 227 | 241 | 255 | 269 | 283 | 297 | 311 | 325 | 339 | 353 | 367 | 380 | 394 | 408 | 422 | 436 |
| 140 | 244 | 258 | 272 | 286 | 300 | 314 | 328 | 342 | 356 | 370 | 384 | 398 | 412 | 426 | 440 | 454 |
| 150 | 262 | 276 | 290 | 304 | 318 | 332 | 346 | 360 | 374 | 387 | 401 | 415 | 429 | 443 | 457 | 471 |

Although Buchanan saw the need for narrow radial lands at the tip and shank end of the file, he avoided narrow radial lands in the waist portion 14 because conventional wisdom held that to provide narrow lands in this portion of the file would require that the waist portion 14 be widened. However, widening the waist portion 14 leads to similar transportation 25 and stress concentration 27, 29 because a wider waist causes stiffness. Therefore, Buchanan elected to narrow the waist portion but widen the lands relative to the tip and shank portions.

The prior art also teaches that a file having a straight or uniform taper but narrow radial lands 17 along its entire working length 14 would experience unacceptable levels of transportation 25 due to, for example, flexing of the waist portion as either the shank or tip ends 13, 15 thread into the root canal R or their cutting or scraping edges drag across the walls of canal R. Buchanan is indicative of the lengths that endodontic designers will go to in order to avoid narrow lands in the waist portion 14 of the file. Compared to the current invention, Buchanan's design is complex and more costly to manufacture.

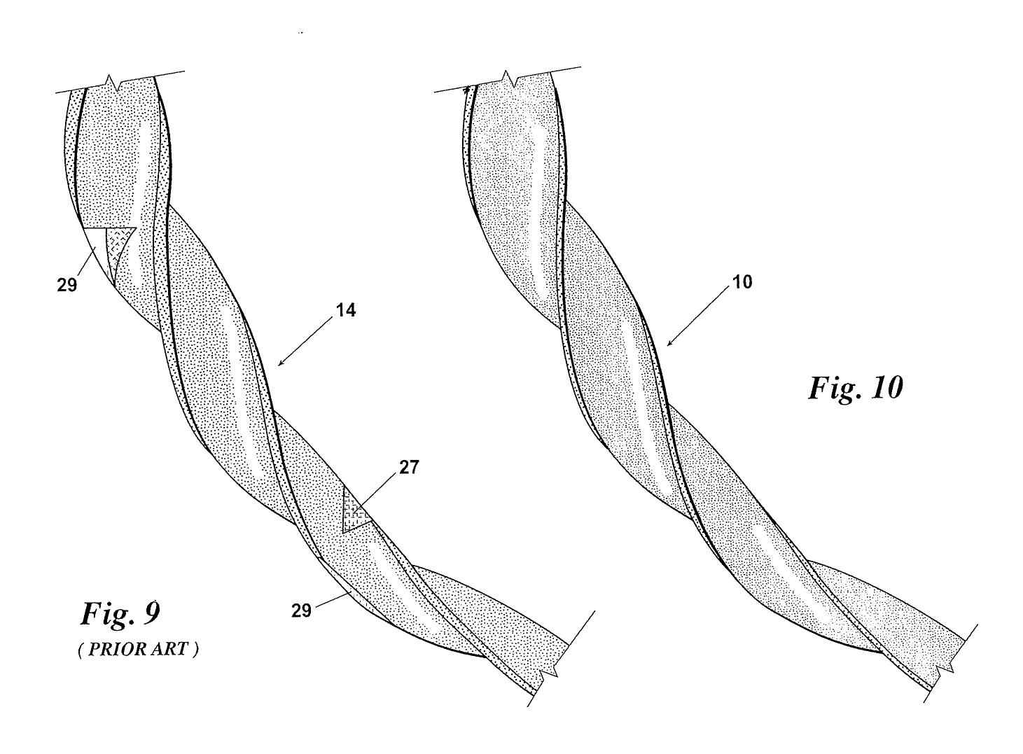

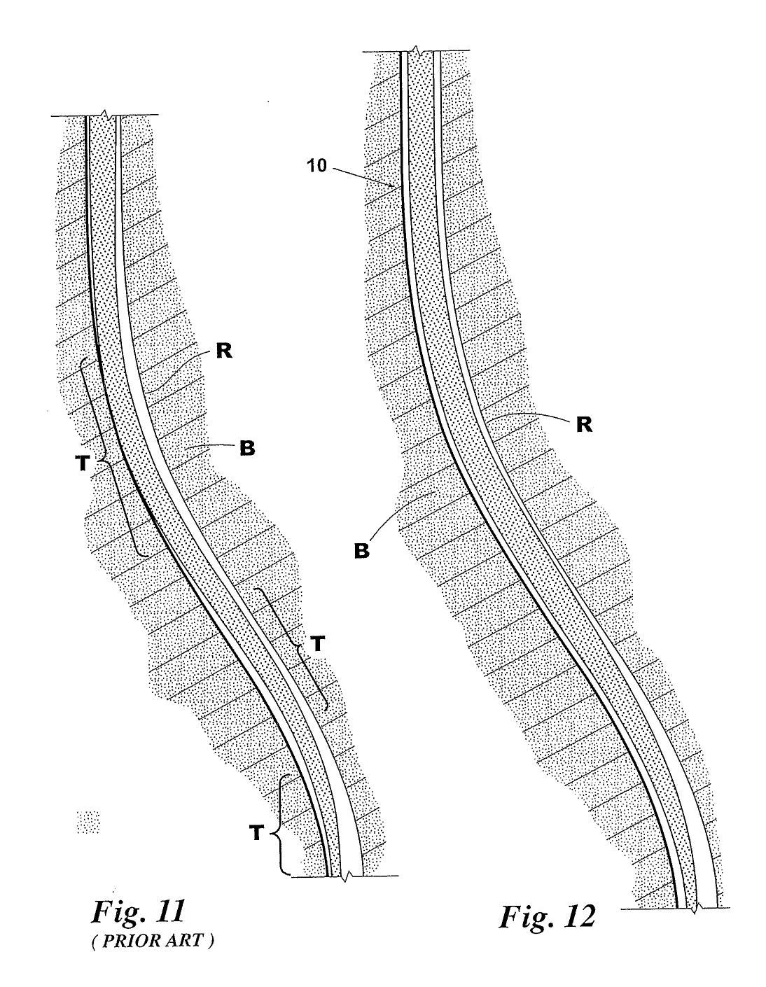

Referring now to FIGS. 8, 10 & 12 a preferred embodiment of an endodontic file made according to this invention was tested in a simulated root canal R in a resin block B. Unexpectedly and surprisingly, the file 10 exhibited no mid-root transportation in its waist portion 14 as the file traversed a 45° curvature. Furthermore, thermal spectroscopy indicated no areas of severe or moderate stress concentrations in the waist portion 14 or along the working length 24.

The fact that improved endodontic file 10 experiences no mid-root transportation and has no areas of stress concentration was demonstrated in subsequent testing. Two PROFILE® files (DENTSPLY Tulsa Dental Specialties, Tulsa, Okla.) were made according to this invention and compared under the same set of test conditions to other prior art, sharp-cutting non-landed files (see Table 4). One of the PROFILE® files was made out of M-WIRE™ NiTi wire (DENTSPLY Tulsa Dental Specialties, Tulsa, Okla.) and the other was made out of NiTi wire. The advantage of the M-WIRE is in enhanced resistance to cyclic fatigue. The straight taper of file 10 in combination with the narrow radial lands 17 along its working length 24 improved cutting efficiency by a factor of about 1.4.

TABLE 4
Cyclic fatigue and cutting efficiency of various endodontic
files having a 0.04 taper and a 25 mm working length.

| | M-WIRE ™ NiTi Wire | | | NiTi Wire | | |
|---|---|---|---|---|---|---|
| | Non-Landed | | Landed | Non-Landed | | Landed |
| | | FLEX- | PROFILE ® | Twisted | | PROFILE ® |
| | K-File | MASTER ® | (land width < | File | K-File | (land width ≈ |
| | (sharp Δ) | (sharp convex Δ) | <0.101 mm) | (sharp Δ) | (sharp Δ) | 0.102 mm) |
| Cyclic Fatigue | 16.16 | 3.45 | 4.73 | 2.88 | 2.00 | 2.31 |
| (min) | | | | | | |
| Efficiency | 2.24 | 1.41 | 1.47 | 1.43 | 1.43 | 1.08 |
| (mm/sec) | | | | | | |

Unexpected and surprisingly, a reduction of about 50% in land width (about 0.05 mm as opposed to 0.102 mm), translated into doubling the cyclic fatigue, increasing cutting efficiency by about 50% while at the same time eliminating mid-root transportation with no areas of severe or moderate stress concentrations along the working length.

While an endodontic file having narrow radial lands along its entire working length has been described with a certain degree of particularity, many changes may be made in the details of construction and the arrangement of components without departing from the spirit and scope of this disclosure. An endodontic file according to this disclosure, therefore, is limited only by the scope of the attached claims, including the full range of equivalency to which each element thereof is entitled.

What is claimed:

1. A method for reducing mid-root transportation of an endodontic file during cleaning and shaping of a root canal, the method comprising:
shaping a root canal with an endodontic file made of a shape memory material and including a uniform tapered working length no greater than 16 mm with at least two right-hand helical-shaped flutes and radial lands between the flutes, the flutes each forming a cutting edge with a neutral rake angle, the radial lands all along the working length having a land width in a range of 0.025 mm (0.001 in) to 0.075 mm (0.003 in.) as measured in a plane perpendicular a central axis of rotation of the longitudinal body.

2. A method according to claim 1 wherein a land width of the radial lands all along a waist portion of the uniform tapered working length is no greater than a land width of the radial lands located above or below the waist portion, the waist portion being in a range of D₄ to D₁₁ as measured from a tip end of the uniform tapered working length.

3. A method according to claim wherein the land width is in a range of 0.025 mm to 0.51 mm (0.002 in.)

4. A method according to claim 1 wherein the land width is in a range of 0.025 mm to 0.034 mm (0.0013 in.).

5. A method according to claim 1 wherein the land width is a same land width all along the uniform tapered working length.

6. An endodontic file comprising:
a longitudinal body made of a shape memory material and including a uniform tapered working length no greater than 16 mm with at least two right-hand helical-shaped flutes and radial lands between the flutes, the flutes each forming a cutting edge having a neutral rake angle, the radial lands all along the uniform tapered working length having a land width in a range of 0.025 mm (0.001 in) to 0.075 mm (0.003 in.) as measured in a plane perpendicular a central axis of rotation of the longitudinal body.

7. An endodontic file according to claim 6 wherein a land width of the radial lands all along a waist portion of the uniform tapered working length is no greater than a land width of the radial lands located above or below the waist portion, the waist portion being in a range of D₄ to D₁₁ as measured from a tip end of the uniform tapered working length.

8. An endodontic file according to claim 6 wherein the land width is in a range of 0.025 mm to 0.51 mm (0.002 in.)

9. An endodontic file according to claim 6 wherein the land width is in a range of 0.025 mm to 0.034 mm (0.0013 in.).

10. An endodontic file according to claim 6 wherein the land width is a same land width all along the uniform tapered working length.
